(19) United States
(12) Patent Application Publication
(10) Pub. No.: US 2015/0006714 A1
(43) Pub. Date: Jan. 1, 2015

(54) RUN-TIME VERIFICATION OF MIDDLEBOX ROUTING AND TRAFFIC PROCESSING

(71) Applicant: Microsoft Corporation, Mountain View, CA (US)

(72) Inventor: Navendu Jain, Seattle, WA (US)

(21) Appl. No.: 13/931,711

(22) Filed: Jun. 28, 2013

(51) Int. Cl. H04L 12/26

(52) U.S. Cl. CPC H04L 43/0876
USPC 709/224

(57) ABSTRACT

The subject disclosure is directed towards verifying correct middlebox operation/behavior, including while the middlebox is running in a network. Probe traffic is sent to a middlebox, with the middlebox output monitored to determine whether the middlebox correctly processed the traffic. For example, the verification may be directed towards evaluating that only legitimate traffic is passed, and that the legitimate traffic is correctly routed. Also described is the use of a summary data structure to track traffic flows, and the detection of routing loops.

### BACKGROUND

Middleboxes are network components deployed in a network to perform specific tasks with respect to network traffic. Example middleboxes include load balancers, firewalls, virtual private networks (VPNs), intrusion prevention devices, network address translators (NATs) and optimizers; (switches and routers are generally not considered middleboxes). These are examples of middleboxes implemented as hardware appliances. Software implementations are also possible where the middlebox traffic processing functionality may be implemented as an application running on a commodity network device or server. For example, a software load balancer may run in virtual machines (VMs).

Middleboxes can have a relatively high failure rate compared to other network devices that may cause them to deviate from policy and/or otherwise behave incorrectly, or simply not run at all. Thus, an operational challenge for a large network infrastructure is to ensure the correct operation of middleboxes. For example, incorrect behavior (e.g., due to misconfiguration) can result in routing loops. Other incorrect behavior includes allowing traffic that is supposed to be blocked to pass through, and/or blocking traffic that is supposed to be passed. A firewall device may fail due to overload of incoming traffic. A load balancer may not distribute service traffic properly across its servers, and intrusion prevention device may allow malware to get through, and so on. As is understood, this risks the security and/or performance of network components as well as the applications and services hosted thereon.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards sending probe traffic to a middlebox in a network, and monitoring middlebox traffic output. Additionally, other output from middleboxes such as log files, error messages, and rule evaluation outcomes may also be monitored. The output is used to determine whether the middlebox is operating correctly with respect to performing routing and/or traffic processing.

In one aspect, vantage points, each comprising a source of probe traffic, are coupled to a middlebox. The vantage points are configured to send probe traffic directly addressable to the middlebox, or to one or more applications for which the middlebox is intended to carry or process traffic. A monitoring mechanism receives output from the middlebox. Because the probe traffic is known (e.g., crafted or monitored at the input), expected versus actual middlebox behavior may indicate a middelbox problem. Logic analyzes the middlebox output to evaluate the middlebox behavior.

One aspect is directed towards performing runtime verification of a middlebox, including logging traffic flow data output from a middlebox interface via a data structure that represents information corresponding to each flow, and analyzing the information in the summary data structure. The analysis determines whether only legitimate traffic is passed, and that the legitimate traffic is forwarded to correct endpoints by correlating what middlebox interface is carrying what traffic flows.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components/used for runtime verification of middlebox behavior, in which probe traffic is sent to the middlebox, with the output monitored to evaluate the middlebox behavior, according to one example implementation.

FIG. 2 is a flow diagram representing example steps for probing and monitoring a middlebox for properly blocking/passing traffic, according to one example implementation.

FIG. 3 is a flow diagram representing example steps for probing and monitoring a middlebox for correctly processing and forwarding traffic, according to one example implementation.

FIG. 4 is a flow diagram representing example steps that may be taken to probe and monitor a middlebox for correctly processing and forwarding traffic, including with crafted packets, according to one example implementation.

FIG. 5 is a block diagram representing example components/used for runtime verification of middlebox behavior, in which probe traffic is sent to the middlebox, with one or more various outputs monitored to collect data for analysis to evaluate the middlebox behavior, according to one example implementation.

FIGS. 6A and 6B comprise a block diagram and a flow diagram, respectively, each directed towards detecting routing loops, according to one example implementation.

FIG. 7 is a block diagram representing exemplary non-limiting networked environments in which various embodiments described herein can be implemented.

FIG. 8 is a block diagram representing an exemplary non-limiting computing system or operating environment in which one or more aspects of various embodiments described herein can be implemented.

### DETAILED DESCRIPTION

Various aspects of the technology described herein are generally directed towards performing run-time verification of middleboxes, that is, verifying correct operation while the middleboxes are online and running (as opposed to taken offline and statically/manually tested). Run-time verification of outgoing traffic may be performed against their specification on middleboxes to ensure correct data plane functionality (e.g., forwarding and processing of legitimate traffic while blocking of unwanted traffic, robustness to handle high load) and consistent control plane functionality (e.g., no routing loops or black-holed packets).

In one aspect, probe traffic comprising crafted packets and/or flows or input-monitored packets and/or flows are sent into the network. Run-time middlebox verification is performed based on a combination of sending the probe traffic from multiple external vantage points, along with traffic monitoring on the outgoing interface or interfaces of middleboxes.

One aspect is directed towards integrating run-time verification with the use of a summary data structure to efficiently encode what traffic flows are being passed through and their flow information (e.g., traffic volume) on middleboxes. Another aspect is directed towards detecting routing loops by checking if a previously seen packet for a flow traverses the device again, using the packet's Time-to-live (TTL) field.

Yet another aspect is directed towards verifying that only legitimate traffic is passed, and further that legitimate traffic is forwarded to the correct endpoints by correlating what interface is carrying what traffic flows. Still another aspect is directed towards a technique of verifying the reachability of endpoints via specified paths by checking traffic across interfaces and/or destinations.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and networking in general.

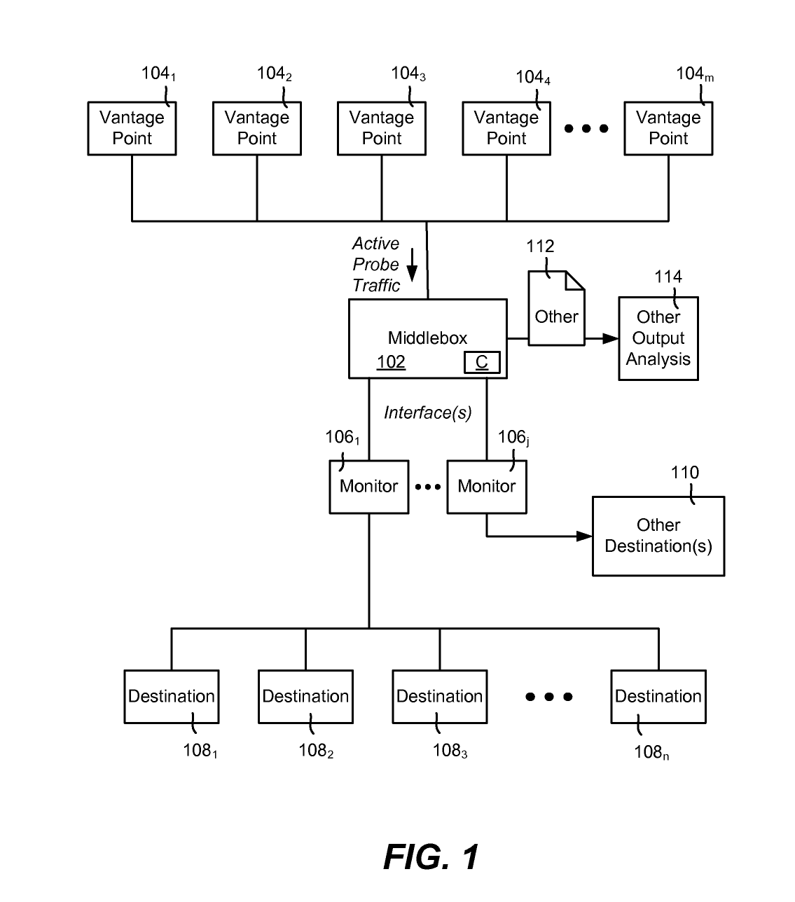

FIG. 1 shows runtime verification of a middlebox 102 based upon sending probe traffic from multiple vantage points 104₁-104ᵢ, e.g., probe traffic sources within a datacenter that contains the middlebox and/or outside the datacenter. Any practical number of vantage points 104₁-104ₘ may be used, and the vantage points 104₁-104ᵢ may be arranged for various purposes, e.g., outside a datacenter, from a source (possibly another middlebox) in the datacenter, and so on. A middlebox may be arranged with more than one input interface.

Traffic monitoring is performed on the output of the middlebox 102. This may be at the outgoing interface or interfaces of middleboxes (shown as monitors 106₁-104ⱼ, although only one such outgoing interface may be present), and/or at one or more destination machines 108₁-108ₖ or 110. For example, the outgoing flow level traffic across network interfaces (except management) of a middlebox may be continuously monitored, e.g., sampled via sFlow or NetFlow. As another example, if a destination machine is accessible to the sender of the probe traffic, then that destination's reachability may be verified, as well as analyzed as to what was received. In any event, the output of the middlebox, whether at a monitor on an interface and/or a destination machine, is validated against the probe traffic.

In addition to traffic monitoring, any other output from middleboxes such as log files, error messages, and rule evaluation outcomes may also be analyzed. This is represented in FIG. 1 by the other “document” 112 and the other output analysis (block) 114.

In one aspect, multiple external points are set up to generate probe traffic to stress-test or otherwise test middlebox configurations (e.g., check blocking of all ports except 80 and 8080). The probes may be used to verify reachability, and detect routing loops. In FIG. 1, the block labeled “C” in the middlebox 102 represents a configuration, e.g., in the form of a file.

Probe traffic may be sent at different rates. This allows stress testing of a middlebox at or near capacity versus other conditions. Any or all of the source(s)/vantage point(s) may include controller logic for this purpose, which may be coordinated among multiple sources/vantage points.

The probe traffic may be engineered or selected based upon their content to generate traffic flows based on specified rules on the probed middleboxes, including based on random combinations of flow identifiers to verify behavior not covered in the rules, or both. By way of example, consider testing a firewall. The configuration “C” may be such that traffic for all ports except 80 and 8080 is to be blocked. By sending “bad” packets with random port numbers other than 80 or 8080 at different operating conditions (e.g., low load rate versus high load rate), and counting how many of those are input versus how many get through to the monitor or monitors, the behavior of the firewall may be validated. Conversely, or at the same time, packets with ports 80 or 8080 may be injected into the firewall to ensure that the “good” probing packets are properly getting through. Note that the number/size of the probing packets sent can be sufficiently large to stress test the firewall, as firewalls may fail when there is too much traffic. Counting and persisting information regarding the packets are described below.

The traffic may include packets that are crafted for active probing. Alternatively, packets may be monitored at the input and (at least some) sent as probe traffic. For example, an incoming packet to be forwarded may be briefly captured and monitored to detect that a middlebox should block that packet; when sent, the middlebox output is monitored to see if the packet actually was blocked.

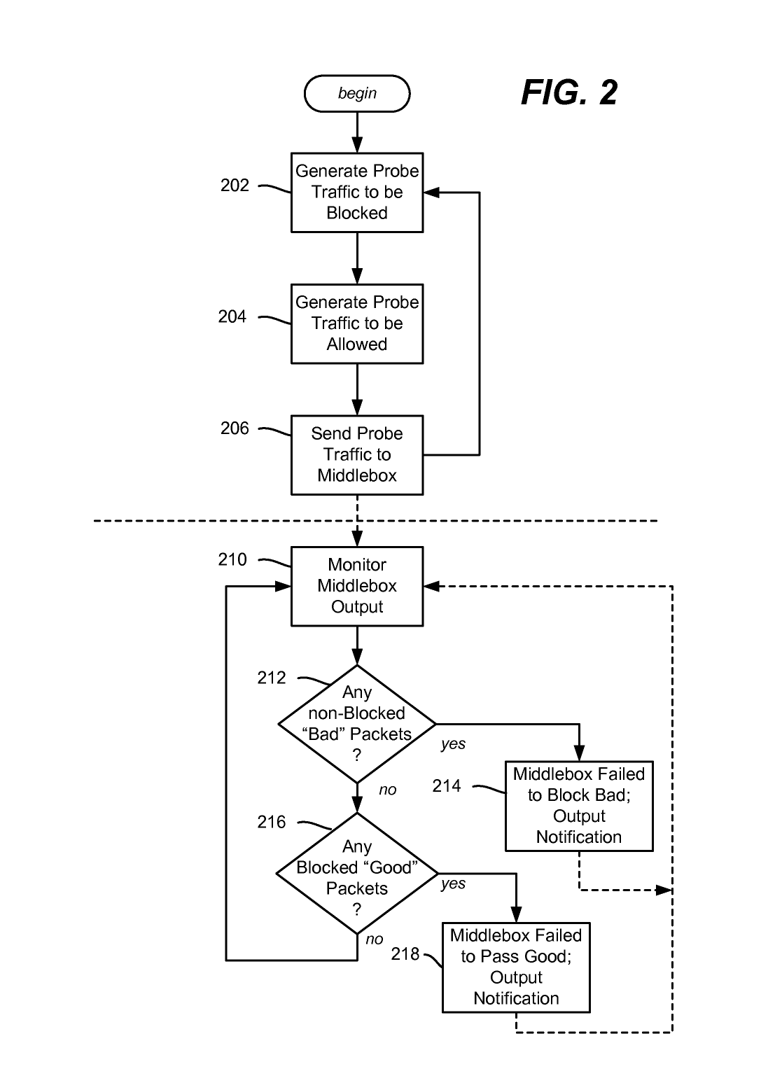

FIG. 2 shows a simplified flow diagram of a general concept, beginning at steps 202 and 204 where probe traffic is generated for blocked ports, and for non-blocked ports, respectively. Step 206 sends the probe traffic into the firewall; note that the sending rate, amount and so forth may be controlled.

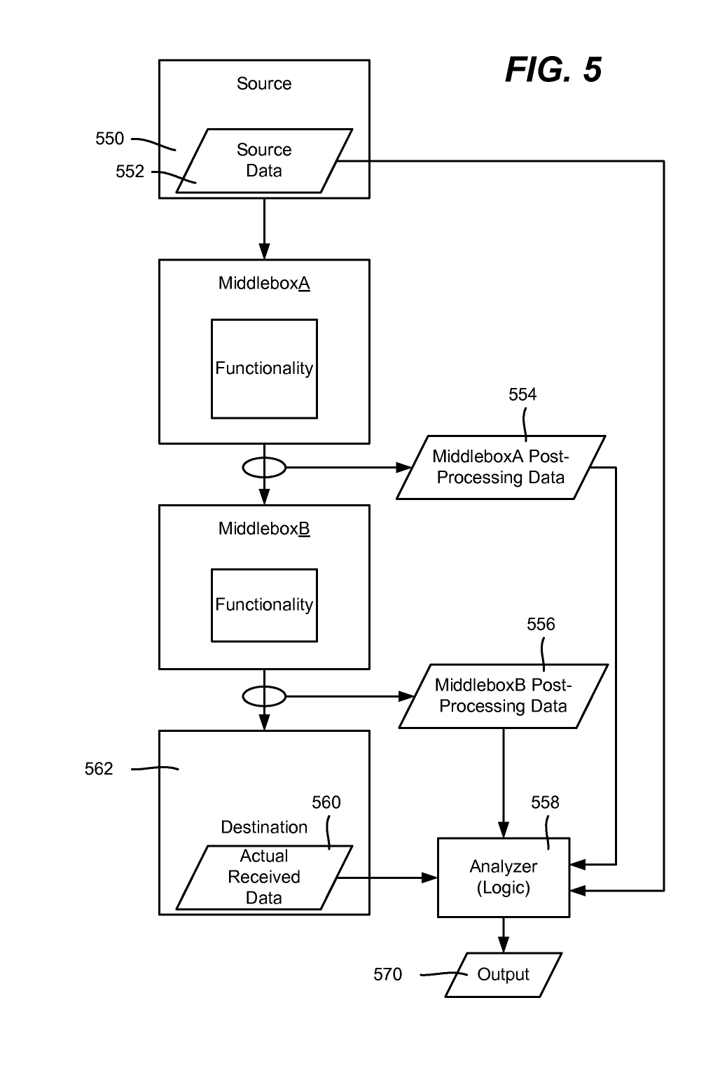

Step 210 represents monitoring the firewall's output. If bad packets that need to be blocked have passed through (step 212), then the firewall failed to block traffic that was supposed to be blocked (step 214); a notification may be output, e.g., to a tester, administrator and/or a log or the like. Similarly, if good packets are blocked (step 216), then the firewall failed for blocking good packets (step 218); a notification may be output. Logic, implemented anywhere in the network (e.g., at an analyzer 558 of FIG. 5) may perform the analysis/evaluation. Note that the probing may end at the first failure or some other number of failures, but need not end on a failure, and what is considered a failure may vary (e.g., some small percentage of good packets may be allowed to be blocked without considering the device as failing). Otherwise the probing may end by time, number of packets, by manual halting, and so forth (not shown). Note further that the run-time verification means that the firewall is typically also processing other (non-probing) traffic at the same time, whereby the “good” probing packets may contain some data indicating that they are probing packets so that the number of probe packets input into the firewall can be correlated with the number of probe packets detected at the output.

Instead of a firewall, consider that the middlebox comprises an intrusion prevention device. The logic of FIG. 2 basically applies, except that instead of blocked ports and good ports, packets with known malware signatures are generated as the “bad” probe traffic that is supposed to be blocked.

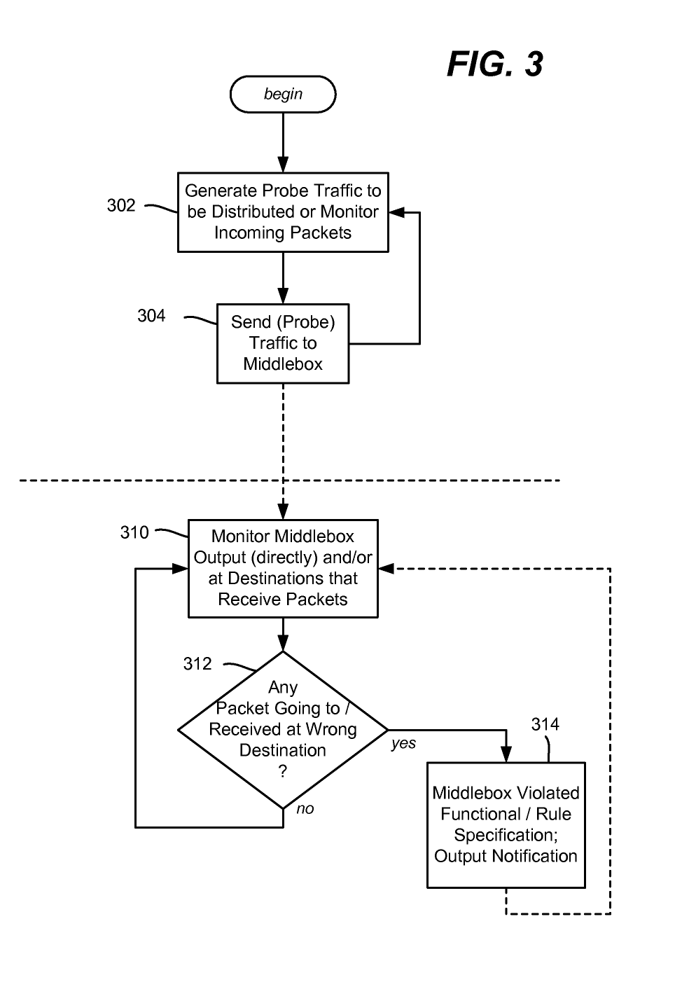

FIG. 3 exemplifies another concept, namely probing to verify proper operation of a load balancer middlebox. This may be based upon crafting the packets (step 302), sending them to the middlebox (step 304) as probe traffic and monitoring them after sending (step 310) to see if they are properly distributed. Instead of crafting the packets, incoming packets (or some sampling thereof) may be monitored and used as at least some probe packets by comparing them against what the middlebox actually outputs and/or what the destinations ultimately receive.

If a packet goes to (or is destined for) the wrong destination, as evaluated at step 312, then the middlebox violated a functional/rule specification (step 314); a notification may be output. Note that monitoring may end or may continue after such a policy violation, as represented by the dashed line. Further note that step 310 may be performed directly at the middlebox output and/or at the destinations among which a middlebox distributes or sends traffic.

By way of example, consider that a load balancer is configured to hash packet information (e.g., five tuple fields of a TCP/IP or UDP/IP flow, an IP address or HTTP data) to distribute a packet to one of one-hundred servers. Probe packets may be crafted with IP addresses that will hash to known values, and sent into the middlebox to see if the balancing is correct. Round-robin, weighted round-robin and other load-balancing (least connection/least response time) techniques may be evaluated by counting, capturing and/or comparing relevant data, including at the output interfaces and/or the destination servers.

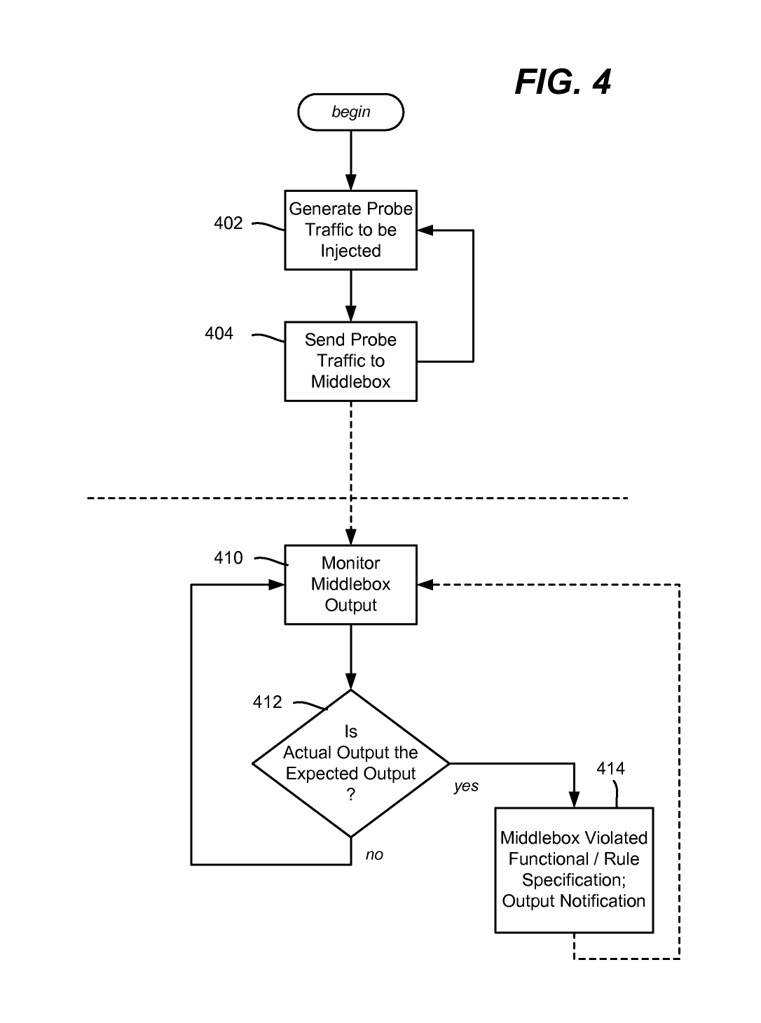

FIG. 4 shows a general input versus output evaluation used to verify correct middlebox behavior. Network address translators, virtual private networks and optimizers may be evaluated by crafting or selecting appropriate probe packets (step 402), and outputting them into a corresponding middlebox (step 404). The output is monitored (step 410) to compare the resultant output with the known input and compared with the output. If the output is not what is expected (step 412), the middlebox failed to comply with policy (step 414); a notification may be output. Note that monitoring may end or may continue after such a policy violation, as represented by the dashed line. For example, various network addresses that are to be translated by a network address translator are sent to the middlebox to determine what actual translation resulted. An optimizer that performs network coding can be sent known packets to see if they are coded correctly at the output.

Reachability can be determined by sending traffic to destinations that are accessible to the probing system (e.g., a tester's or company's own servers). The packets and/or flows that comprise the traffic may be evaluated at the interfaces of a middlebox (or each middlebox of a set) and analyzed against the traffic that reached the destination.

By way of example, FIG. 5 shows a probing source 550 having source data 552 that is destined for a destination to which the tester or the like has access. The source and/or destination may be outside the datacenter. The source data 552 passes through two middleboxes, MiddleboxA and MiddleboxB, resulting in post-processing data (554 and 556) being available from each middlebox for use. An analyzer 558 or the like (which may be implemented anywhere in the network, such as in the source, or another device in the datacenter with the middlebox, or in a cloud service) may evaluate the source data 552, the middleboxes' post processing data 554 and 556, and/or the actual received data 560 at a destination 562 to determine how each middlebox acted on the data, as well as what any downstream intermediaries did. For example, this can be used to verify that a middlebox is failing, a combination of middleboxes is failing, the middleboxes are operating properly but another intermediary is modifying the data in some way, and so forth. The analyzer 558 may provide output 570, e.g., to a human and/or machine for use as desired.

Turning to aspects related to traffic counting and information logging, one or more various space-efficient data structures and corresponding algorithms such as a counting Bloom filter, bitmaps, or a Count-min sketch may be used. For example, consider that a flow is being monitored and logged by mapping flow data into a summary data structure. Each logged flow, its carried interface and one or more flow identifiers (e.g., a five tuple of source address, destination address, source and destination ports, protocol) are recorded in a summary data structure (DS) that can answer approximate set membership and COUNT queries. As is known, such data structures may efficiently encode what traffic flows are being passed through and their volume.

As a more particular example, consider logging a flow to track how many bytes are sent from a source address and port to a destination address and port. A count-min sketch may be used, based upon hashing the relevant identifiers into one cell in each of a number of rows (corresponding to different hash functions) of the data structure. The size of the packet (or a value representative thereof) may be added to each mapped cell, for example. The minimum value in the mapped cells among the rows based on mapping (e.g., hashing) the information of any given tuple provides a reasonably accurate estimate (with bounded maximum error) of the tracked information, which in this example was the number of bytes sent, and/or detected at the interface of a middlebox, and/or received at a destination.

The flow identifiers encoded in a summary data structure may be checked against the probes and traffic that is supposed to be blocked according to device configurations. For example, intentionally “bad” packets intended to be blocked are not supposed to reach the middlebox output interface (or a destination), whereby a counting data structure (initialized to zero) that counts such packets may show a zero count for such data if the middlebox is properly operating. This may ensure correctness of the various conditions, including that only legitimate traffic is passed, and further the legitimate traffic is forwarded to the correct endpoints by correlating what interface is carrying what traffic flows. The reachability of endpoints may be verified via specified paths by checking traffic across interfaces and destinations.

Another aspect of probing is directed towards detecting routing loops. To this end, the testing system or the like checks whether a packet for a flow traverses the device again as a result of a routing loop. This is done by saving packet data that will not change (e.g., packet metadata including destination and sequence number) before sending, and checking incoming packets' data against what has been already seen.

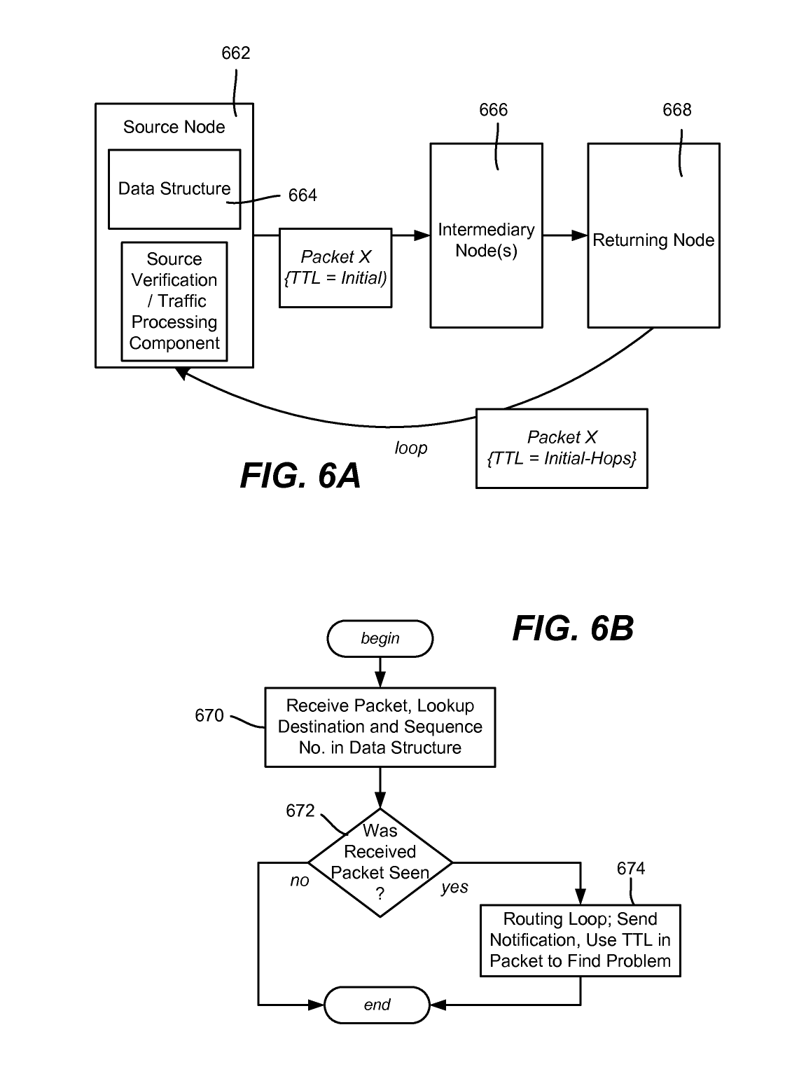

FIGS. 6A and 6B exemplify this aspect. Consider that a source packet X is sent from a source 662 (FIG. 6A) towards some other destination, with the packet data that is not changeable by other nodes (e.g., the destination and sequence number and possibly other packet metadata) encoded/mapped/saved as a representation thereof into a data structure 664, e.g., by hashing. The packet may travel through any number of hops (zero or more intermediary nodes) 666 on its way towards the destination. If a node 668 returns the original packet back to the source 662 instead of forwarding it on towards the destination, a routing loop problem has occurred. Note that there may not be any intermediary nodes, e.g., the node 668 may be the next hop and return the original packet back to the source 662

To detect this, when a packet is received (step 670 of FIG. 6B), the source can look up (e.g., rehashing if hashed) the saved packet information and recognize from the data structure 664 that the source 662 has previously seen this packet (step 672). If so, there is a routing loop detected (step 674); a notification may be sent to a user and/or log or the like.

To further pinpoint where the problem occurred, the source node can use the Time-To-Live (TTL) field (step 674). As is known, the TTL field contains a value that is decremented at each hop and a message returned to the sender when the value reaches zero. Thus, if the routing loop problem is repeatable, the source may progressively set the TTL values in increments of one, e.g., as 1, 2, 3, and so on, respectively, to determine the intermediary nodes through which the return packet traversed. When the TTL value is set to 1, the next hop of the source receiving that packet will decrement the TTL value to zero, which in turn would trigger an ICMP ‘Time To Live exceeded in transit’ message to be sent to the source address. In this way, the source can determine the ordered list of nodes on the routing path of the returned packet and use this information to help find the problem e.g., send this information to a network operator for analysis.

As can be seen, there is described run-time middlebox verification based on combining sending probe traffic from vantage points and traffic monitoring on the output of middleboxes, e.g., outgoing interfaces and/or at a destination. The technology is able to verify whether only legitimate traffic is passed, and further whether the traffic is forwarded to the correct endpoints by correlating what interface is carrying what traffic flows. The technology is able to verify the reachability of endpoints via specified paths by checking traffic across interfaces and destinations

In other various aspects, run-time verification may be integrated with the use of a summary data structure to efficiently encode what traffic flows are being passed through, as well as their volume on middleboxes. Routing loops may be detected by checking if a previously seen packet for a flow traverses the device again using packet Time-to-live (TTL) field.

### Example Networked and Distributed Environments

One of ordinary skill in the art can appreciate that the various embodiments and methods described herein can be implemented in connection with any computer or other client or server device, which can be deployed as part of a computer network or in a distributed computing environment, and can be connected to any kind of data store or stores. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the resource management mechanisms as described for various embodiments of the subject disclosure.

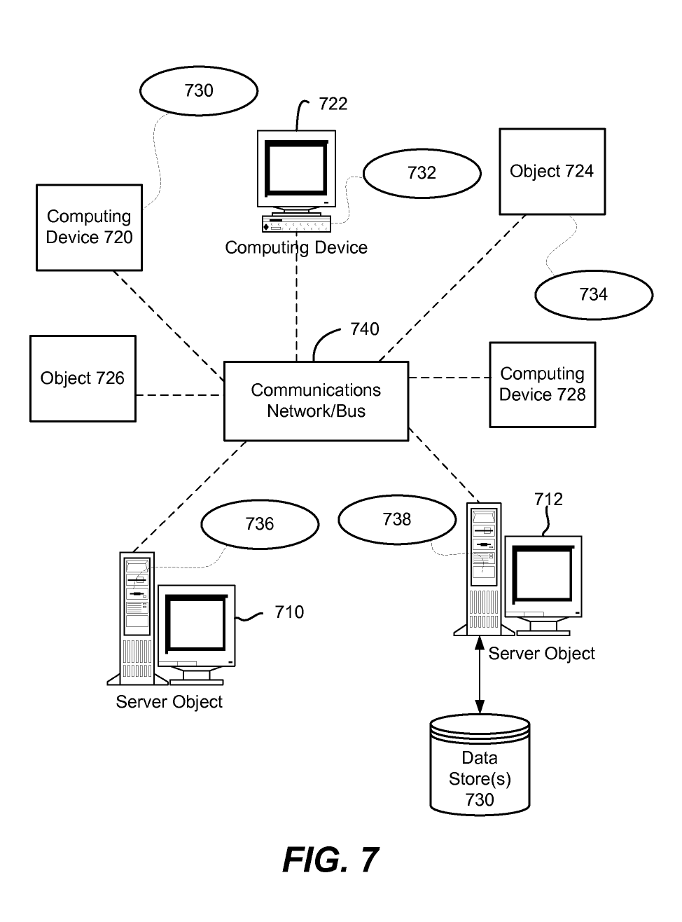

FIG. 7 provides a schematic diagram of an example networked or distributed computing environment. The distributed computing environment comprises computing objects 710, 712, etc., and computing objects or devices 720, 722, 724, 726, 728, etc., which may include programs, methods, data stores, programmable logic, etc. as represented by example applications 730, 732, 734, 736, 738. It can be appreciated that computing objects 710, 712, etc. and computing objects or devices 720, 722, 724, 726, 728, etc. may comprise different devices, such as personal digital assistants (PDAs), audio/video devices, mobile phones, MP3 players, personal computers, laptops, etc.

Each computing object 710, 712, etc. and computing objects or devices 720, 722, 724, 726, 728, etc. can communicate with one or more other computing objects 710, 712, etc. and computing objects or devices 720, 722, 724, 726, 728, etc. by way of the communications network 740, either directly or indirectly. Even though illustrated as a single element in FIG. 7, communications network 740 may comprise other computing objects and computing devices that provide services to the system of FIG. 7, and/or may represent multiple interconnected networks, which are not shown. Each computing object 710, 712, etc. or computing object or device 720, 722, 724, 726, 728, etc. can also contain an application, such as applications 730, 732, 734, 736, 738, that might make use of an API, or other object, software, firmware and/or hardware, suitable for communication with or implementation of the application provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for example communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 7, as a non-limiting example, computing objects or devices 720, 722, 724, 726, 728, etc. can be thought of as clients and computing objects 710, 712, etc. can be thought of as servers where computing objects 710, 712, etc., acting as servers provide data services, such as receiving data from client computing objects or devices 720, 722, 724, 726, 728, etc., storing of data, processing of data, transmitting data to client computing objects or devices 720, 722, 724, 726, 728, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 740 or bus is the Internet, for example, the computing objects 710, 712, etc. can be Web servers with which other computing objects or devices 720, 722, 724, 726, 728, etc. communicate via any of a number of known protocols, such as the hypertext transfer protocol (HTTP). Computing objects 710, 712, etc. acting as servers may also serve as clients, e.g., computing objects or devices 720, 722, 724, 726, 728, etc., as may be characteristic of a distributed computing environment.

### Example Computing Device

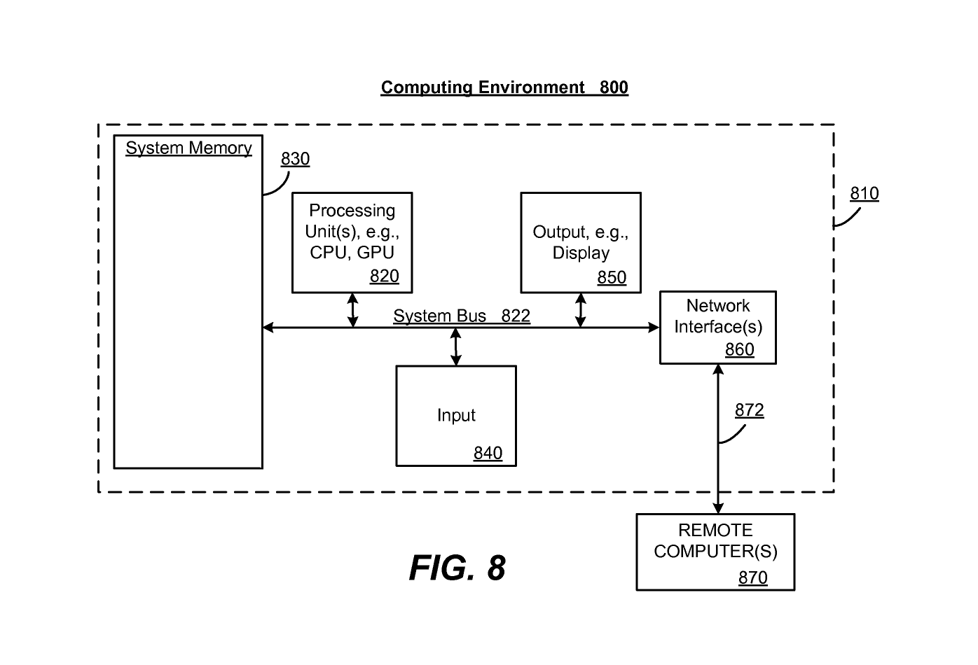

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 8 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 8 thus illustrates an example of a suitable computing system environment 800 in which one or aspects of the embodiments described herein can be implemented, although as made clear above, the computing system environment 800 is only one example of a suitable computing environment and is not intended to suggest any limitation as to scope of use or functionality. In addition, the computing system environment 800 is not intended to be interpreted as having any dependency relating to any one or combination of components illustrated in the example computing system environment 800.

With reference to FIG. 8, an example remote device for implementing one or more embodiments includes a general purpose computing device in the form of a computer 810. Components of computer 810 may include, but are not limited to, a processing unit 820, a system memory 830, and a system bus 822 that couples various system components including the system memory to the processing unit 820.

Computer 810 typically includes a variety of computer readable media and can be any available media that can be accessed by computer 810. The system memory 830 may include computer storage media in the form of volatile and/or nonvolatile memory such as read only memory (ROM) and/or random access memory (RAM). By way of example, and not limitation, system memory 830 may also include an operating system, application programs, other program modules, and program data.

A user can enter commands and information into the computer 810 through input devices 840. A monitor or other type of display device is also connected to the system bus 822 via an interface, such as output interface 850. In addition to a monitor, computers can also include other peripheral output devices such as speakers and a printer, which may be connected through output interface 850.

The computer 810 may operate in a networked or distributed environment using logical connections to one or more other remote computers, such as remote computer 870. The remote computer 870 may be a personal computer, a server, a router, a network PC, a peer device or other common network node, or any other remote media consumption or transmission device, and may include any or all of the elements described above relative to the computer 810. The logical connections depicted in FIG. 8 include a network 872, such local area network (LAN) or a wide area network (WAN), but may also include other networks/buses. Such networking environments are commonplace in homes, offices, enterprise-wide computer networks, intranets and the Internet.

As mentioned above, while example embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the example systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a method, comprising, sending probe traffic to a middlebox in a network, and monitoring middlebox output to determine whether the middlebox is operating correctly according to a specified set of rules with respect to performing routing or traffic processing, or both routing and traffic processing.

2. The method of claim 1 wherein monitoring the middlebox output comprises monitoring data at one or more middlebox output interfaces.

3. The method of claim 1 wherein monitoring the middlebox output comprises monitoring data received at a destination.

4. The method of claim 1 further comprising, analyzing at least one of: a log file, an error message, a rule evaluation outcome, or other data output by the middlebox.

5. The method of claim 1 wherein sending the probe packets comprises sending a probe packet that the middlebox is supposed to block, and wherein monitoring the middlebox output comprises determining whether the middlebox blocks the packet, and/or wherein sending the probe packets comprises sending a probe packet that the middlebox is supposed to pass, and wherein monitoring the middlebox output comprises determining whether the middlebox passes the packet.

6. The method of claim 1 further comprising at least one of: crafting one or more active probe packets for injecting into the middlebox as part of sending the probe traffic, or monitoring input traffic to select one or more packets being sent to the middlebox for use as one or more probe packets.

7. The method of claim 1 further comprising, crafting a packet with content that violates a policy to evaluate whether a firewall or an intrusion detection and prevention system blocks the packet.

8. The method of claim 1 further comprising, sending a plurality of packets to evaluate whether a load balancer middlebox correctly distributes the packets among servers according to a current configuration of the middlebox.

9. The method of claim 1 further comprising, logging flow data, including maintaining a data structure into which one or more flow identifiers associated with a flow are mapped to one or more locations in the data structure, and updating the one or more locations in the data structure to represent the flow data.

10. The method of claim 1 wherein monitoring the middlebox output comprises evaluating input data or information corresponding to the input data, against output data or information corresponding to the output data.

11. The method of claim 1 further comprising, detecting a routing loop, including detecting that a received packet has been seen before, and using a Time-To-Live (TTL) field to determine a node path associated with the routing loop.

12. The method of claim 1 further comprising, controlling a rate of sending the probe traffic.

13. In a computing environment, a system comprising, a plurality of vantage points, each vantage point comprising a source of probe traffic coupled to a middlebox and configured to send the probe traffic to the middlebox, a monitoring mechanism configured to receive output from the middlebox, and logic configured to analyze the middlebox output to evaluate the middlebox behavior based upon the probe traffic and the middlebox output.

14. The system of claim 13 wherein the middlebox is configured at least in part as: a load balancer device, a firewall device, a virtual private network device, an intrusion prevention device, a network address translator device, a proxy, or an bandwidth optimizer device.

15. The system of claim 13 further comprising, a data structure configured to track information related to middlebox operation.

16. The system of claim 15 wherein the data structure is configured to track flows based upon one or more flow identifiers associated with each flow or the contents of the packets in the flows.

17. The system of claim 13 further comprising, a mechanism configured to store data that corresponds to already seen packets in a data structure and to check a received packet against the data store to determine whether the received packet traverses a node again in a routing loop.

18. The system of claim 13 wherein the logic is configured to verify whether only legitimate traffic is passed, or whether traffic is forwarded to correct endpoints, or both verify whether only legitimate traffic is passed and whether traffic is forwarded to correct endpoints.

19. The system of claim 13 wherein the logic is configured to verify reachability of endpoints via specified paths by checking traffic across one or more middlebox interfaces or one or more destinations, or both.

20. One or more computer-readable storage media having computer-executable instructions, which when executed perform steps, comprising, performing runtime verification of a middlebox, including logging traffic flow data output from a middlebox interface via a data structure that represents information corresponding to each flow, and analyzing the information in the data structure, including to determine according to policy data whether only legitimate traffic is passed and that the legitimate traffic is forwarded to correct endpoints by correlating what middlebox interface is carrying what traffic flows and checking that the legitimate traffic is reaching the intended destination.
